(19) United States
(12) Patent Application Publication
(10) Pub. No.: US 2018/0194178 A1
(43) Pub. Date: Jul. 12, 2018

(54) METHOD FOR DETERMINING AT LEAST ONE TYRE-SPECIFIC CHARACTERISTIC, DRIVER ASSISTANCE SYSTEM AND MOTOR VEHICLE

(71) Applicant: VALEO Schalter und Sensoren GmbH, Bietigheim-Bissingen (DE)

(72) Inventor: Nicolas Jecker, Bietigheim-Bissingen (DE)

(73) Assignee: VALEO Schalter und Sensoren GmbH, Bietigheim-Bissingen (DE)

(21) Appl. No.: 15/742,247

(22) PCT Filed: Jul. 4, 2016
(86) PCT No.: PCT/EP2016/065699

§ 371 Date: Jan. 5, 2018

(30) Foreign Application Priority Data
Jul. 7, 2015 (DE) 10 2015 110 952.2

(51) Int. Cl. B60C 25/00; B60C 11/24; B60C 25/05; G07C 5/08; G06K 9/62; G01M 17/02

(52) U.S. Cl. CPC B60C 25/007; B60C 11/246; G01M 17/027; G07C 5/0816; G06K 9/62; B60C 25/0554

(57) ABSTRACT

The invention relates to a method for determining at least one tyre-specific characteristic of a tyre (15) of a motor vehicle (1), in which an area of the tyre (15) of the motor vehicle (1) is captured by means of at least one vehicle-side camera (3, 6), wherein a tyre wall (16) of the tyre (15) with a tyre inscription (19) is captured as the area by means of the at least one camera (3, 6), and the tyre inscription (19) is identified by means of an evaluation device (13) and the at least one tyre-specific characteristic is determined on the basis of the tyre inscription (19). The invention also relates to a driver assistance system (2) and a motor vehicle (1).

The invention relates to a method for determining at least one tyre-specific characteristic of a tyre of a motor vehicle, in which an area of the tyre of the motor vehicle is captured by means of at least one vehicle-side camera. The invention also relates to a driver assistance system and a motor vehicle.

It is already known from the prior art to attach cameras to motor vehicles in order to capture, for example, a surrounding area of the motor vehicle in images. The fact that areas of the motor vehicle itself can also be captured by means of the camera is shown, for example, in DE 10 2010 055 583 A1. In particular, an area of at least one wheel of the motor vehicle is captured there and a parameter is determined by means of a computing device, the parameter describing the roadworthiness of the motor vehicle with respect to the wheel. Such a parameter may be, for example, an air pressure of a tyre of the wheel. In order to ensure a high accuracy in the determination of these parameters, high demands are usually placed on the cameras with regard to their resolution.

It is an object of the present invention to determine a tyre-specific characteristic of a motor vehicle tyre in a particularly simple and accurate manner.

This object is achieved according to the invention by a method, a driver assistance system and a motor vehicle having the features according to the independent patent claims.

The method is used to determine at least one tyre-specific characteristic of a tyre of a motor vehicle. In the method, an area of the tyre of the motor vehicle is captured by means of a vehicle-side camera. In addition, a tyre wall of the tyre with a tyre inscription is captured as the area by means of the at least one camera, and the tyre inscription is identified or extracted by means of an evaluation device and the at least one tyre-specific characteristic is determined on the basis of the tyre inscription.

A tyre in combination with a rim forms a wheel of a motor vehicle which is known per se. The tyre herein is the part of the wheel via which the wheel can be rolled on a carriageway of the motor vehicle. For this purpose, the tyre has a tread running along an outer circumference of the tyre. The area of the tread of the tyre, which bears on the carriageway of the motor vehicle, for example when the wheel rolls, forms a so-called tyre contact area of the tyre. Bordering the tread, the tyre has side areas or sidewalls which form the tyre walls of the tyre. In an intended installation position of the wheel on the motor vehicle, the tyre in this case comprises an outer tyre wall facing a surrounding area of the motor vehicle and an inner tyre wall facing a wheel house of the motor vehicle.

The tread of the tyre has a tread pattern, wherein the tread pattern is a tyre-specific characteristic or a tyre-specific parameter and may be configured differently, for example, depending on tyre manufacturers and/or tyre types. Other data of the tyre, in particular geometric data of the tyre, for example, a diameter of the tyre, the tyre contact area or a track width, are also tyre-specific characteristics and therefore in particular dependent on the tyre manufacturer and/or tyre type.

Because a driving behaviour or a movement behaviour of the motor vehicle is also significantly influenced by the tyres, it is desirable to determine the tyre-specific characteristics as accurately as possible. Thus, for example, a driver assistance system of the motor vehicle can be provided with particularly accurate data about the movement behaviour of the motor vehicle. The tyre-specific characteristics in this case are stored in the tyre inscription or the tyre designation on the tyre wall of the tyre and provided, for example in coded form, as alphanumeric characters and/or symbols on the tyre wall. In order to identify or extract the tyre inscription, the tyre wall is captured in at least one image by means of the at least one vehicle-side camera. The captured image is evaluated by means of the evaluation device, which has, for example, an image processing device, and thereby extracts the tyre inscription from the captured image of the tyre wall. The at least one tyre-specific characteristic or the at least one tyre-specific parameter is determined based on the tyre inscription extracted or identified by the evaluation device, the tyre inscription containing the at least one tyre-specific characteristic, in particular in coded form.

In contrast to the prior art, therefore, a tread of the tyre itself is not captured and evaluated, but rather the at least one tyre-specific characteristic or the at least one tyre-specific parameter is determined particularly easily and quickly on the basis of the tyre inscription. This tyre-specific characteristic can then advantageously be provided to a driver assistance system for further use, for example for the particularly accurate calculation of the movement behaviour of the motor vehicle.

Particularly preferably, a tyre manufacturer and/or at least a tyre size designation and/or an indicator of weather suitability of the tyre is captured and identified as the tyre inscription. The tyre manufacturer in this case may include the brand of the tyre and a type or a model of the tyre, wherein the tyre manufacturer may be stored as a lettering on the tyre wall. The tyre size designation may include geometric data of the tyre, for example, a tyre cross-sectional width, a rim diameter, a tyre height-to-width ratio, and the tyre contact area, and other data, such as a tyre load classification number and a permissible maximum speed for the tyre. These tyre size designations are usually coded and provided on the tyre wall in the form of combinations of code letters and code numerals associated with corresponding precise tyre-specific data. The indicator of weather suitability is an indication provided on the tyre wall on whether the tyre is a summer, winter or all-season tyre. In particular, the course of profile and tread depth are dependent on the weather suitability of the tyre. The corresponding tyre-specific parameter can be determined in a particularly simple and rapid manner based on this tyre inscription.

Preferably, characteristics are provided or given for predetermined tyre manufacturers and/or predetermined tyre size designations, and the associated characteristic is selected on the basis of the captured and identified tyre manufacturer and/or the at least one captured and identified tyre size designation and is determined as the at least one tyre-specific characteristic. In other words, for example, the predetermined tyre manufacturers and/or the predetermined tyre size designations are thus assigned the corresponding characteristics in a database or a list. The database can be, for example, an in-vehicle database stored on a storage unit of the motor vehicle and/or a database external to the vehicle, for example, an Internet-based database which can be accessed by the evaluation device. As soon as the tyre manufacturer and/or the tyre size designation has been identified by the evaluation device, the corresponding characteristic associated with the identified tyre manufacturer and/or with the identified tyre size designation can be read from the database or the list quickly and easily, and can be determined as the at least one tyre-specific characteristic.

According to one embodiment of the invention, a tyre-specific tread pattern, in particular a tyre-specific tread depth, is determined as the at least one tyre-specific variable on the basis of the captured and identified tyre manufacturer and/or on the basis of the captured and identified tyre size designation and/or on the basis of the captured and identified indicator of weather suitability. This tyre-specific profile of the tread, in particular a shape of the profile, for example a profile of tread grooves of the profile, and the tread depth, i.e. the depth of the tread grooves, in particular depends on the tyre manufacturer and the weather suitability of the tyre. Thus, driving characteristics of a tyre may vary among manufacturers and/or among summer and winter tyres. In order to be able to determine, for example, the course of movement of the tyre particularly accurately, on the basis of the tyre inscription the at least one camera and the evaluation device can capture which tyre is currently mounted on the motor vehicle, and accordingly a calculation of the course of movement of the tyre can be adjusted.

According to one development, a tread of the tyre of the motor vehicle is captured by the at least one camera at least partially and in addition a current tread pattern, in particular a current tread depth of the tyre, for capturing a state of wear of the tyre, is captured and determined on the basis of the captured tread. Since the tyre-specific tread depth determined on the basis of the identified tyre inscription corresponds in particular to a value of the tread depth of a new tyre, the current tread depth can be additionally determined from the tread capture of the tyre. It can thereby be recognized whether the tyre has worn down and thus whether a traffic safety of the motor vehicle is impaired.

Preferably, a tyre-specific water displacement capacity of the tyre is determined on the basis of the tyre manufacturer and/or at least the tyre size designation and/or the indicator of weather suitability, in particular based on the tyre-specific and/or the current profile. The tyre-specific water displacement capacity describes a tyre-specific amount of water on a carriageway of the motor vehicle, above which the tyre floats on the carriageway. In the present case, the interest is mainly focused on capturing when a so-called aquaplaning occurs, i.e. a floating of the tyre on a wet carriageway. In aquaplaning, a wedge of water slides under the tyres on a wet carriageway and thus leads to a loss of grip of the tyre on the carriageway. When aquaplaning occurs, guiding and braking forces can no longer be transmitted to the carriageway, and the motor vehicle can skid. The tyre-specific amount of water is determined to prevent this. This tyre-specific amount of water is a tyre-specific water volume flow which can no longer be displaced from the tyre within a predetermined time and thus slides under the tyre. An aquaplaning time for the motor vehicle can be determined on the basis of this tyre-specific amount of water.

The amount of water present on the carriageway of the motor vehicle at which aquaplaning occurs depends on the design of the tyre, in particular on the geometric characteristics of the tyre, the tread depth and the weather suitability of the tyre. These tyre-specific characteristics can be extracted from the tyre inscription captured by the at least one camera and be provided for determining the tyre-specific quantity of water. Until now, standard values were generally accepted for calculating the aquaplaning time, but these were very inaccurate. With knowledge of the tyre-specific water displacement capacity of the motor vehicle, the calculation of the aquaplaning time can now advantageously be carried out more accurately and reliably.

In one development of the invention, a current amount of water on the carriageway of the motor vehicle is determined and a current difference value between the tyre-specific and the current amount of water is formed. In addition, warning levels for a floating of the tyre are provided for predetermined difference values and one of the warning levels is selected as a function of the current difference value. Such warning levels are intended to warn a driver of the motor vehicle of a risk of aquaplaning and/or indicate the occurrence of aquaplaning. In particular, the risk of aquaplaning in this case becomes greater the smaller the current difference value becomes. As soon as the difference is approximately zero, this means that the current amount of water on the carriageway corresponds to the tyre-specific amount of water that can no longer be displaced by the tyre, and thus aquaplaning is just occurring in the motor vehicle.

It proves to be advantageous if an output device is provided in the motor vehicle, on which the warning levels are output as warning signals to a driver of the motor vehicle. Such an output device can be, for example, a display device which visually outputs to the driver the risk of aquaplaning and the occurrence of aquaplaning. In this case, colour-coded light signals can be shown on the display device for the driver, wherein each colour corresponds to a warning level. The output device may also be an acoustic output device, for example a loudspeaker, which generates a warning tone, for example. The warning tone can be output more intensively as the risk of aquaplaning rises, for example with an increasing volume. Thus, the driver can be signalled in a particularly insisting manner about the risk of aquaplaning or existing aquaplaning.

According to one embodiment of the invention, at least one geometric characteristic of the tyre, in particular a track width and/or a rim offset, is determined as the tyre-specific characteristic on the basis of the captured and identified tyre size designation. The track width in this case is influenced in particular by a tyre width and/or a tyre air pressure, the values of which can be extracted from the tyre size designation. The rim offset is a distance between a centre of the rim of the wheel and an inner bearing surface of a wheel flange of the wheel. These parameters influence in particular a course of movement of the tyre, and thus a driving behaviour of the motor vehicle. By determining the tyre-specific parameters, the driving behaviour of the motor vehicle can be determined particularly accurately.

In a development of the invention, the at least one tyre-specific geometric characteristic is provided for calculating odometry parameters of the motor vehicle. The odometry parameters of the motor vehicle serve, for example, for determining a position, an orientation and a driving state of a motor vehicle, for example based on a wheel rotation of the wheels of the motor vehicle. In particular, in this case the geometry of the tyre has an influence on the wheel rotation and thus on the odometry parameters and the accuracy of the position determination. According to the prior art, standard parameters were usually assumed, so that an accurate position determination could not be ensured and only insufficiently so.

According to one embodiment of the invention, a course of movement of the motor vehicle is determined for a driver assistance system in a parking operation of the motor vehicle supported by the driver assistance system on the basis of the calculated odometry parameters. The driver assistance system is thus, in particular, a parking assistance system here. In parking assistance systems, for example, a parking space for the motor vehicle is measured when the motor vehicle drives past the parking space. The motor vehicle can thereupon carry out the parking operation autonomously or semi-autonomously or provide the driver with current position data of the motor vehicle to assist with parking. The current position data of the motor vehicle in this case are determined using the odometry parameters. According to the prior art, standard parameters for the tyres are generally provided for odometry, wherein it is possible for the motor vehicle to hold an unfavourable parking position due to the resulting inaccurate position determination, for example, and for the driver to have to correct the parking position if necessary. By means of the embodiment of the method according to the invention shown here, an improved parking operation and an improved parking position can be made possible, in that the odometry parameters are determined particularly accurately on the basis of the tyre-specific characteristics and thus the course of movement of the motor vehicle during parking can be calculated particularly accurately.

Particularly preferably, the at least one camera is arranged on a side mirror of the motor vehicle, wherein a tyre of a front wheel of the motor vehicle of a motor vehicle side associated with the side mirror and a tyre of a rear wheel of the motor vehicle of the motor vehicle side associated with the side mirror is at least partially in a capture range of the at least one camera. A camera can be arranged in each of the side mirrors for capturing both motor vehicle sides. The respective camera in this case captures the front wheel and the rear wheel of its associated motor vehicle side and thus, in particular, the tyre walls of both tyres. The cameras can also be used, for example, for detecting a surrounding area of the motor vehicle. Thus, at least one tyre-specific characteristic of all four tyres of the motor vehicle can be captured by means of only one camera on each motor vehicle side.

It can be provided that a steering angle of the motor vehicle is captured and, on the basis of the steering angle, it is determined whether the tyre wall of the tyre is located in a capture range of the at least one camera, wherein the capture and identification of the tyre inscription is initiated as soon as the tyre wall of the tyre is within the capture range of the at least one camera. The invention herein is based on the finding that the tyre wall can be captured particularly accurately when the tyre is turned in, in particular fully turned in, and the tyre wall of the tyre faces the camera. Whether and how far a tyre is turned in can be determined on the basis of the steering angle of the motor vehicle. Steering angle sensors are already provided in the motor vehicle and are designed to determine the steering angle, for example for an electronic stability program of the motor vehicle. However, the steering angle determined by the steering angle sensor can also be used to initiate the determination of the at least one tyre-specific characteristic. The determination process of the at least one tyre-specific variable is thus triggered by means of the steering angle. Thus, when the tyre is turned in, it can be checked at any time, on the basis of the tyre inscription, for example, whether a tyre of the motor vehicle has been changed, and the at least one tyre-specific parameter is thereupon redetermined.

The invention also relates to a driver assistance system for a motor vehicle with at least one vehicle-side camera for detecting an area of a tyre of the motor vehicle. In this case, the at least one camera is designed to capture a tyre wall having a tyre inscription as the area of the tyre. An evaluation device of the driver assistance system is designed to identify or extract the tyre inscription and, on the basis of the tyre inscription, to determine at least one tyre-specific characteristic of the tyre of the motor vehicle. The driver assistance system is, in particular, a parking assistance system or an aquaplaning warning assistance system, which makes use of the tyre-specific characteristic in order to more accurately determine input variables for the driver assistance system, for example, a course of movement during a parking process or a floating time in aquaplaning.

A motor vehicle according to the invention comprises a driver assistance system according to the invention. The motor vehicle is designed in particular as a passenger car.

The preferred embodiments presented with reference to the method according to the invention and their advantages apply correspondingly to the driver assistance system according to the invention and to the motor vehicle according to the invention.

The terms “top”, “bottom”, “front”, “rear”, “horizontal”, “vertical” etc. indicate the positions and orientations given when the tyre is used and arranged as intended on the motor vehicle and where an observer is standing in front of the motor vehicle and looking in the direction of the tyre.

Further features of the invention will become apparent from the claims, the figures and the description of the figures. The features and combinations of features mentioned above in the description as well as the features and combinations of features mentioned below in the description of the figures and/or shown solely in the figures can be used not only in the respectively indicated combination but also in other combinations or in isolation, without abandoning the scope of the invention. Thus, embodiments of the invention which are not explicitly shown and explained in the figures, but which emerge and can be generated by separate combinations of features from the described embodiments, are to be regarded as encompassed and disclosed. Embodiments and combinations of features which thus do not have all the features of an originally formulated independent claim are also to be regarded as disclosed.

In the following, the invention will be explained in more detail with reference to a preferred embodiment as well as with reference to the accompanying drawings, in which:

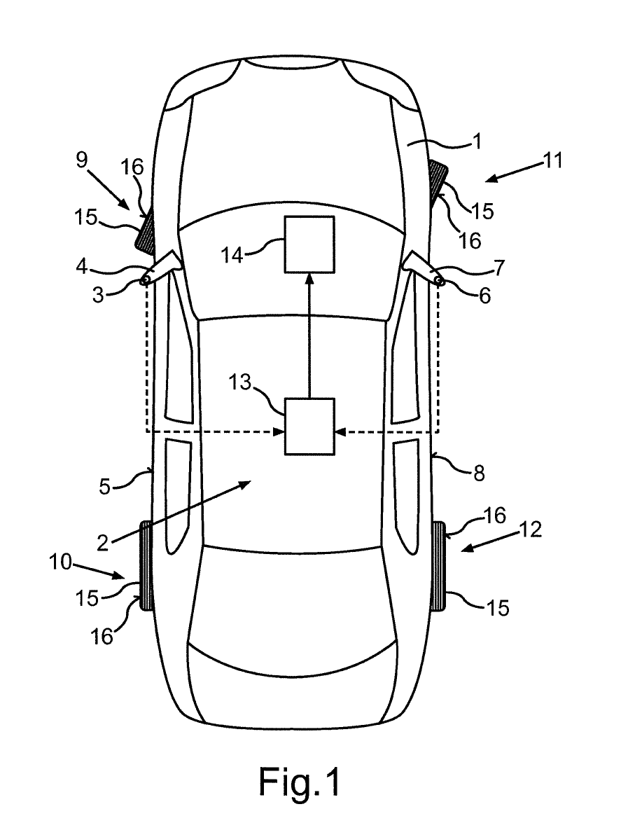

FIG. 1 shows a schematic representation of an embodiment of a motor vehicle according to the invention;

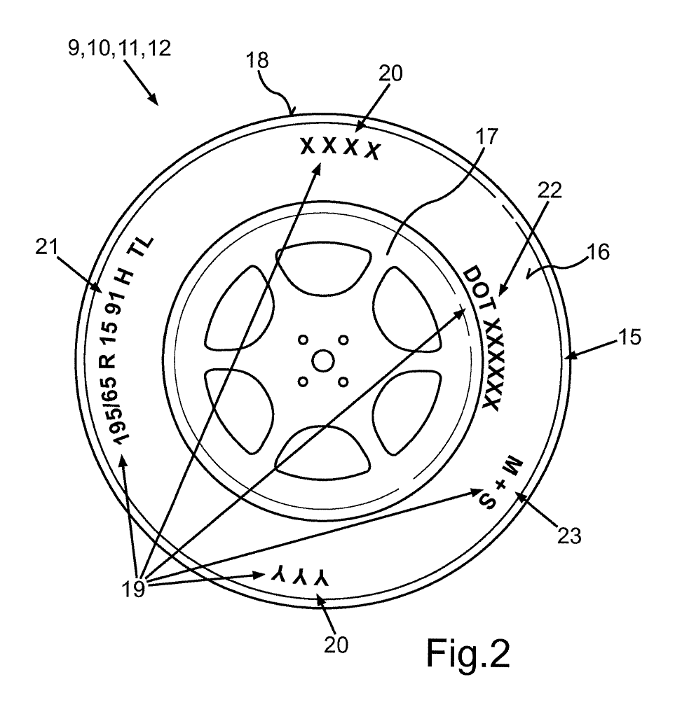

FIG. 2 shows a schematic representation of a tyre of a motor vehicle in a side view;

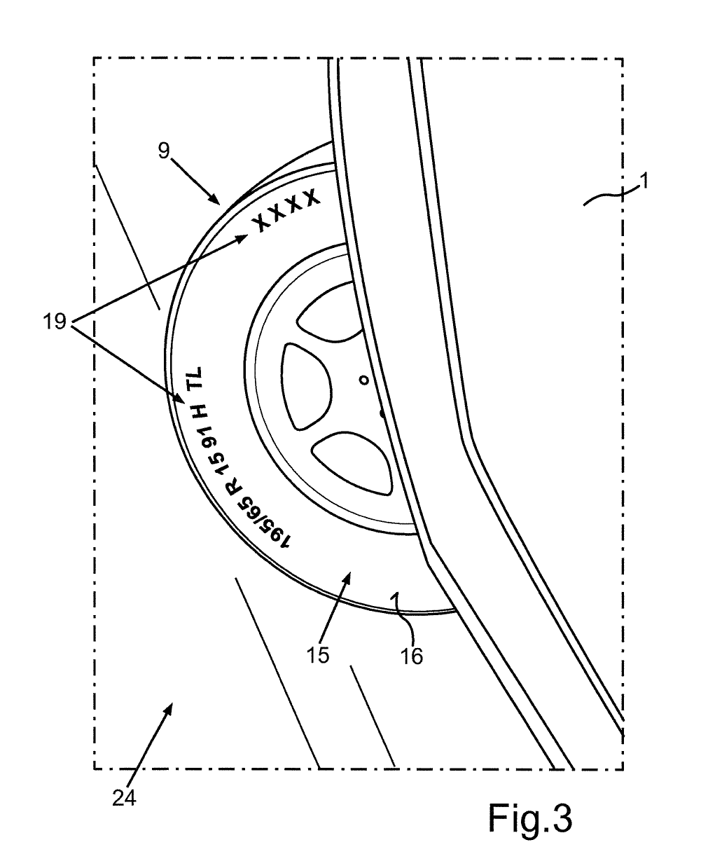

FIG. 3 shows a schematic representation of a tyre of a motor vehicle from the perspective of a camera of the motor vehicle; and

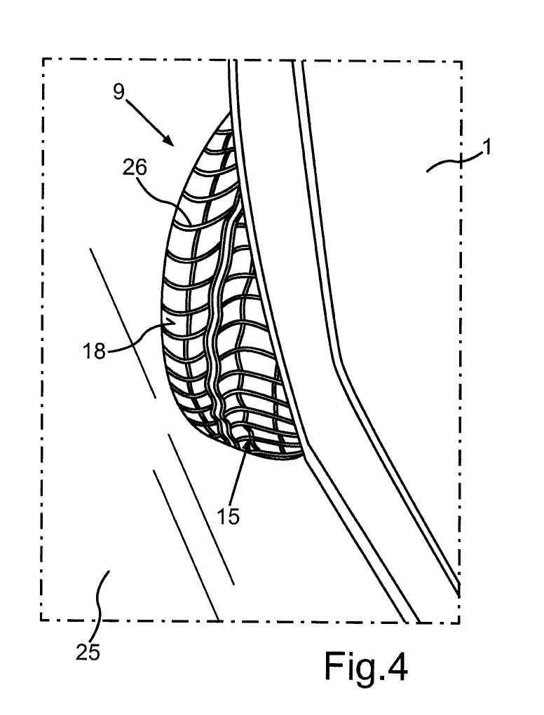

FIG. 4 shows a further schematic representation of a tyre of a motor vehicle from the perspective of a camera of the motor vehicle.

Identical and functionally identical elements are provided with the same reference numerals in the figures.

FIG. 1 shows a motor vehicle 1 with a driver assistance system 2. The driver assistance system 2 is configured in particular as a parking assistant or an aquaplaning assistant. The driver assistance system 2 comprises a first camera 3, which is arranged in a first side mirror 4 on a first side 5. In addition, the driver assistance system 2 comprises a second camera 6 which is arranged in a second side mirror 7 on a second side 8 of the motor vehicle 1 opposite the first side 5.

In a capture range of the first camera 3, there is a first front wheel 9 of the motor vehicle 1 and a first rear wheel 10 of the motor vehicle 1. In a capture range of the second camera 6, there is a second front wheel 11 of the motor vehicle 1 and a second rear wheel 12 of the motor vehicle 1. Each of the wheels 9, 10, 11, 12 has a tyre 15 via which the respective wheel 9, 10, 11, 12 can be rolled for locomotion of the motor vehicle 1 on a carriageway of the motor vehicle 1. The cameras 3, 6 are now designed to capture at least an area of the tyres 15 of the wheels 9, 10, 11, 12 in images.

FIG. 2 shows one of the wheels 9, 10, 11, 12 in a side view. The wheel 9, 10, 11, 12 has the tyre 15 and a rim 17 on which the tyre 15 bears. The tyre 15 comprises a tread 18 which, when the wheel 9, 10, 11, 12 rolls, touches the carriageway of the motor vehicle 1 at least in areas. Side walls, so-called tyre walls, adjoin the tread 18, of which an outer tyre wall 16 facing a surrounding area of the motor vehicle 1 is shown here. The tyre wall 16 of the tyre 15 is provided with a tyre inscription 19. The tyre inscription 19 comprises alphanumeric characters and/or symbols, by which tyre-specific characteristics are stored or described in coded form or directly.

In this case, the tyre inscription 19 may comprise a tyre manufacturer 20 in the form of a lettering, which in particular identifies a brand and a tyre type of the tyre 15. A tyre course of profile and/or a tyre tread depth of the tyre 15 can be determined through the tyre manufacturer 20, for example. In addition, tyre size designations 21 of the tyre 15 can be represented by means of the tyre inscription 19. These tyre size designations 21 may indicate geometrical characteristics and other characteristic numbers of the tyre 15, for example, in the form of combinations of code letters and code numbers. The corresponding tyre-specific, geometric parameters can be assigned to the code letters and code numbers, for example, in a table. Such tyre size designations 21 are, for example, a tyre width, a tyre diameter, a rim diameter, a tyre height-to-width ratio, a tyre cross-sectional width, a tyre contact area, an air pressure of the tyre 15, a track width, a tyre load capacity index 15, and a speed index. In addition, the tyre inscription 19 may include a manufacturer's date 22 in coded form as well as an indicator of weather suitability 23 which identifies the tyre 15 as a winter or all-season tyre.

The tyre wall 16 of the wheels 9, 10, 11, 12 having the tyre inscription 19 is captured in images in this case by the cameras 3, 6 of the driver assistance system 2 of the motor vehicle 1. For this purpose, an image 24 of the tyre wall 16 of the tyre 15 of the wheel 9 having the tyre inscription 19 captured by the camera 3 is shown by way of example in FIG. 3. It can be seen in this case that the tyre wall 16, and thus the tyre inscription 19, are in the capture range of the camera 3, in particular, when the wheel 9 has been turned in. In order to detect the turned-in state of the wheel 9, a steering angle of the motor vehicle 1 can be captured by means of a steering angle sensor (not shown here). Once it has been captured by the steering angle sensor that the wheel 9 is turned in in such a way that the tyre inscription 19 is located in the capture range of the camera 3, a capture process of the tyre inscription 19 is started.

For this purpose, the driver assistance system 2 comprises an evaluation device 13, which is designed to evaluate the captured images 24 of the cameras 3, 6. The evaluation device 13 includes, for example, an image processing device and extracts or identifies the tyre inscription 19 from the tyre wall 16 captured by the cameras 3, 6. On the basis of the tyre inscription 19, the evaluation device 13 determines at least one of the tyre-specific characteristics of the tyre 15. For this purpose, tyre-specific characteristics corresponding to predetermined tyre inscriptions can be stored, for example, in a vehicle-internal database and/or vehicle-external, for example Internet-based, database (not shown here). The evaluation device 13 is designed in this case to read this database and to detect or determine the associated tyre-specific characteristic based on the captured and identified tyre inscription 19.

The determined tyre-specific characteristics can be further processed by the driver assistance system 2. Thus, for example, a driver assistance system 2 configured as a parking assistance system can use the tyre-specific characteristics, in particular the track width and the tyre air pressure 15, to determine in more detail odometry parameters for the motor vehicle 1 during a parking operation of the motor vehicle 1 supported by the driver assistance system 2. So far, standard values for the tyres 15 have usually been specified, but these were too inaccurate for an exact determination of the odometry parameters of the motor vehicle 1.

In a driver assistance system 2 embodied as an aquaplaning assistant, the tyre-specific characteristics of the tyre 15, in particular the tread pattern course and/or the tread pattern depth, can be used to determine a tyre-specific water displacement capacity of the tyre 15. Through the tyre-specific water displacement capacity, a tyre-specific amount of water for the tyres 15 is determined, in the presence of which on the carriageway of the motor vehicle 1, the tyres 15 of the motor vehicle 1 float on the carriageway. In order to determine the tyre-specific water displacement capacity even more precisely, the cameras 3, 6 and the evaluation device 13 can also determine a current profile 26, in particular a current tread depth, of the tyre 15.

In FIG. 4, an image 25 of the wheel 9 captured by the camera 3 shows that the tread 18 of the tyre 15 of the wheel 9 with the current profile 26 is captured for this purpose. On the basis of the captured profile 26, the evaluation device 13 can determine the current tread depth of the tyre 15, which characterizes a wear of the tyre 15 of the wheel 9 and which in particular influences the floating time of the tyre 15 in aquaplaning.

The driver assistance system 2 can also have an output device 14, for example in the form of a display device or a loudspeaker. For example, a risk of aquaplaning can be signalled to a driver of the motor vehicle 1 by means of the output device 14. For this purpose, a current amount of water on the carriageway of the motor vehicle 1 can be determined, for example by a detection device (not shown here), and compared with the tyre-specific amount of water. The smaller a difference between the tyre-specific and the current amount of water, the greater the risk of aquaplaning. This can be communicated to the driver by means of the output device 14, for example by means of a signal tone or a warning light.

1. A method for determining at least one tyre-specific characteristic of a tyre of a motor vehicle, comprising:
capturing an area of the tyre of the motor vehicle by at least one vehicle-side camera;
capturing a tyre wall of the tyre with a tyre inscription as the area by the at least one camera; identifying the tyre inscription by an evaluation device; and
determining the at least one tyre-specific characteristic on the basis of the tyre inscription.

2. The method according to claim 1, wherein tyre manufacturer and/or at least a tyre size designation and/or an indicator of weather suitability is captured and identified as the tyre inscription.

3. The method according to claim 2, wherein characteristics are provided for predetermined tyre manufacturers and/or predetermined tyre size designations and the associated characteristic is selected on the basis of the captured and identified tyre manufacturer and/or the at least one captured and identified tyre size designation and is determined as the at least one tyre-specific characteristic.

4. The method according to claim 2, wherein a tyre-specific tread depth is determined as the at least one tyre-specific characteristic on the basis of the captured and identified tyre manufacturer and/or the captured and identified tyre size designation and/or on the basis of the captured and identified indicator of weather suitability.

5. The method according to claim 1, wherein a tread of the tyre of the motor vehicle is captured by the at least one camera at least partially and in addition a current tread depth of the tyre, for capturing a state of wear of the tyre, is captured and determined on the basis of the captured tread.

6. The method according to claim 2, wherein a tyre-specific water displacement capacity of the tyre is determined on the basis of the tyre manufacturer and/or at least the tyre size designation and/or the indicator of weather suitability, wherein the tyre-specific water displacement capacity describes a tyre-specific amount of water on a carriageway of the motor vehicle, above which the tyre floats on the carriageway.

7. The method according to claim 6, wherein current amount of water on the carriageway of the motor vehicle is determined and a current difference value between the tyre-specific and the current amount of water is formed, wherein warning levels for a floating of the tyre are provided for predetermined difference values and one of the warning levels is selected as a function of the current difference value.

8. The method according to claim 7, wherein an output device is provided in the motor vehicle, wherein the warning levels are output by the output device as warning signals to a driver of the motor vehicle.

9. The method according to claim 2, wherein at least one geometric characteristic of the tyre comprising, a track width and an offset of a rim of the tyre is determined as the tyre-specific characteristic on the basis of the captured and identified tyre size designation.

10. The method according to claim 9, wherein the at least one tyre-specific geometric characteristic is provided for calculating odometry parameters of the motor vehicle.

11. The method according to claim 10, wherein a course of movement of the motor vehicle is determined for a driver assistance system in a parking operation of the motor vehicle supported by the driver assistance system on the basis of the calculated odometry parameters.

12. The method according to claim 1, wherein the at least one camera is arranged on a side mirror of the motor vehicle, wherein a tyre of a front wheel of the motor vehicle (1) of a motor vehicle side associated with the side mirror and a tyre of a rear wheel of the motor vehicle of the motor vehicle side associated with the side mirror is at least partially in a capture range of the at least one camera.

13. The method according to claim 1, wherein a steering angle of the motor vehicle is captured and, on the basis of the steering angle, it is determined whether the tyre wall of the tyre is located in a capture range of the at least one camera, wherein the capture and identification of the tyre inscription is initiated as soon as the tyre wall of the tyre is within the capture range of the at least one camera.

14. A driver assistance system for a motor vehicle, comprising:
at least one vehicle-side camera for detecting an area of a tyre of the motor vehicle, wherein the at least one camera is captures a tyre wall having a tyre inscription as the area of the tyre; and
an evaluation device of the driver assistance system for identifying the tyre inscription and, on the basis of the tyre inscription, to determine at least one tyre-specific characteristic of the tyre of the motor vehicle.

15. A motor vehicle having a driver assistance system according to claim 14.
